(19) United States
(12) Patent Application Publication
(10) Pub. No.: US 2006/0283981 A1
(43) Pub. Date: Dec. 21, 2006

(54) Spray coating nozzle assembly for coating remote areas

(76) Inventors: William T. Mead, Long Beach, CA (US); Jorge A. Millan, Lawndale, CA (US)

Correspondence Address: STETINA BRUNDA GARRED & BRUCKER, 75 ENTERPRISE, SUITE 250, ALISO VIEJO, CA, 92656, US

(21) Appl. No.: 11/154,303

(22) Filed: Jun. 16, 2005

(51) Int. Cl. B05B 9/01

(52) U.S. Cl. 239/526; 239/112; 239/288; 239/588; 239/525; 239/71

(57) ABSTRACT

the invention is a spray nozzle assembly for use with spray guns for coating in remote locations. In detail, the spray coating assembly nozzle assembly includes a tubular member having first and second ends, said first end coupled to the spray gun. A spray nozzle housing is coupled to the second end of the tubular member, the spray nozzle housing containing a spray nozzle. A first device is coupled the housing to observe the remote location coupled, the first device having an optical viewing port. A second device is coupled to the optical view port for providing air under pressure thereto to prevent paint spray from the spray nozzle contacting the optical viewing port.

### BACKGROUND OF THE INVENTION

1. Field of the Invention

The invention relates to the field of spray painting and, in particular, to a spray painting nozzle for use in remote locations

2. Description of Related Art

Spray painting in remote locations is difficult. It requires compact spray nozzles. For example U.S. Pat. No. 6,749,356 Touch-Up Coating Applicator For Remote Locations by W. T. Mead, et al. discloses a semi-flexible line having a spray nozzle at its end. This allows the line to be bent to a shape allowing access to the area to be painted. However, if the area is truly remote and cannot be observed even by use of a mirror, then it is useless because you can not be sure the area has been painted. Thus a visual conformation is a necessity. In U.S. Pat. No. 5,674,183 Fiberscope And Spray Modules by S. Adachi a fiberscope is equipped with a nozzle for spraying cleaning liquid or gas on the end of the fiberscope.

Japanese Patent Abstract No.; JP 09038024 Tip Part Structure Of Endoscope by H. Sota discloses an endoscope having an optical lens assembly wherein a jet of gas or water is passed over the outer surface of the lens assembly to remove liquid deposited thereon. However, such a device would be ineffective if the liquid were paint because the paint would stick to the outer surface and removal by a jet of air would be ineffective.

Thus, it is a primary object of the invention to provide a paint spray nozzle for remote locations which includes a system for direct observation of the area being painted.

It is another primary object of the invention to provide a paint spray nozzle for remote locations which includes a system for direct observation of the area being painted and further provides a second system to prevent paint from obscuring the view of the aircraft being painted.

### SUMMARY OF THE INVENTION

The invention is a spray nozzle assembly for use with spray guns for coating in remote locations. In detail, the spray coating assembly nozzle assembly includes a tubular member having first and second ends, said first end coupled to the spray gun. A spray nozzle housing is coupled to the second end of the tubular member, the spray nozzle housing containing a spray nozzle. A first device is coupled the housing to observe the remote location, typically a remote video camera, and which includes an optical viewing port. Alternately, the first device can be a fiber optic scope.

A second device is coupled to the optical view port for providing air under pressure thereto to prevent coating spray from the spray nozzle contacting the optical viewing port. The second device includes a hood extending from the optical sensing device and an air supply system for providing air to said hood for preventing coating material from reaching said optical sensing device. Preferably, the air supply system includes a manifold about the hood and a plurality of holes extending from the manifold to the interior of the hood with the source of air coupled to the manifold. The spray nozzle assembly further includes a device to illuminate the remote location, which is preferably a battery powered flashlight.

The tubular member can be made from a flexible, semi-flexible or rigid material. Thus the nozzle assembly can be inserted in to remote locations, where areas need coating or paint touch up. The air delivery system prevents the optical viewing system and light from being covered by paint or other coatings.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a simplified view of the paint spray system.

FIG. 2 is a cross-section view of the paint spray system nozzle.

FIG. 3 is a cross-sectional view of the paint spray nozzle system shown in FIG. 2 illustrating details of the air distribution system over the camera and light

FIG. 4 is a cross-sectional view of FIG. 3 taken along the line 44

### DESCRIPTION OF THE PREFERRED EMBODIMENT

Referring to FIG. 1, an air powered spray gun 10 having a body 12, pistol grip 14 and trigger 16. The body is coupled to a supply of coating material or paint via line 18 and to a pressurized air supply line 14 via the pistol grip 14. A flexible tubular member 22 is coupled by its first end 24 to the body 12 of the spray gun 10 and by its second end to a spray nozzle head 26 at its first end 27. The tubular member 22 includes two internal lines, a first line 28 is coupled to the body 12 and receives coating material when the trigger 16 is “pulled” and a second line 30 coupled via regulator valve 32 to the air line 14.

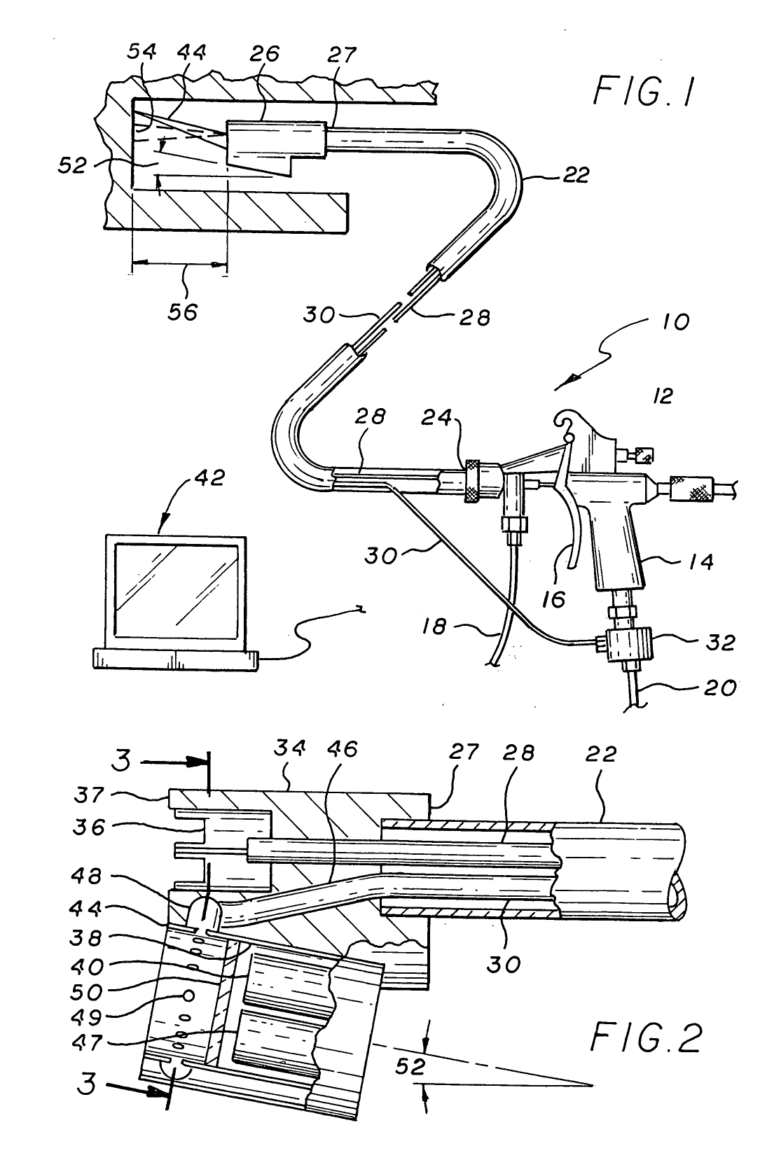

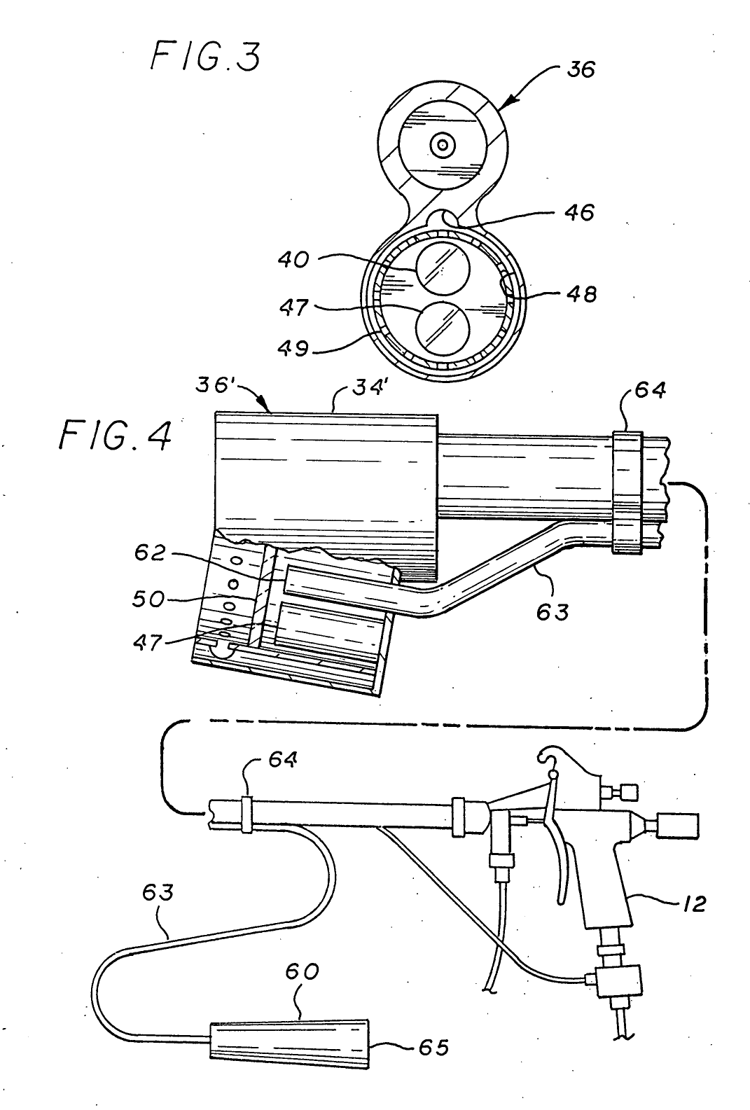

Still referring to FIG. 1 and additionally to FIGS. 2 and 3, the spray nozzle head 26 includes a housing 34, having a spray nozzle 36 mounted at the end of line 37 and coupled to line 20. A compartment 38 at the second end 37 is located next the spray nozzle head 26 contains a portable battery powered video camera 40 that is designed to send video pictures to the video monitor 42 shown in FIG. 1. The camera 40 is recessed in the compartment 38 such that a hood 44 is formed in front of the camera. Also mounted in the compartment 38 is a battery flashlight 47. A passage way 46 has a first end in communication with the hood 44 and a second end connected to the line 30. In detail, the passage way 46 is coupled to a circular manifold 48 having a plurality of holes 49 in communication with the interior of the hood 44. This insures that the air is distributed evenly across the camera 40 and flashlight 47. Optionally, a disposable plastic lens 50 may be positioned in front of the camera and flashlight 47 to insure that they are never contaminated with coating material. The camera 40 and flashlight 47 are positioned in the compartment 38 at an angle 52 such that it focuses on the area 54 that the spray nozzle 36 will deposit coating material when spray gun 10 is activated a the proper distance 56. Of course, the use of a hood is not mandatory, but recommended for optimal protection of the video camera 40.

FIG. 4 illustrates an alternate version wherein a fiber optic scope 60, having a sensing end 62 by means of fiber optic cable 63, is used instead of a video camera. Here the end 62 of the fiber optic scope is mounted in the housing g housing 34′ of the spray nozzle 36′. The viewing end 65 is located in proximity to the spay gun 10. Bands 64 couple the fiber optic cable to the tubular member 22. The remaining portions of the housing 34′ remain identical to configuration of the housing 34 shown in FIG. 2

Therefore, it can be that seen spray painting of remote areas can be accomplished by the subject invention with the assurance that operator will always be able to see the area being coated. It should also be noted that the tubular member 22 can be made of semi-flexible material or even rigid material. If semi-flexible material is used it can be bent to the desired shape to reach the remote area. If rigid material is used, the use of the spray nozzle assembly becomes limited.

While the invention has been described with reference to a particular embodiment, it should be understood that the embodiment is merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to the painting apparatus manufacturing industry.

1. A spray nozzle assembly for use with spray guns for coating in remote locations, the spray coating assembly nozzle assembly comprising:
a tubular member having first and second ends, said first end coupled to the spray gun;
a spray nozzle housing coupled to said second end of said tubular member, said spray nozzle housing containing a spray nozzle;
first means to observe the remote location coupled to said housing, said first means having an optical viewing port; and
second means coupled to said optical view port for providing air under pressure thereto to prevent paint spray from said spray nozzle contacting said optical viewing port.

2. The spray nozzle assembly as set forth in claim 1 wherein:
said second means includes an optical sensing device;
said second means includes:
a hood extending from said optical sensing device; and
an air supply system for providing air to said hood for preventing coating material from reaching said optical sensing device.

3. The spay nozzle assembly as set forth in claim 2 wherein:
said air supply system includes:
a manifold about said hood;
a plurality of holes extending from said manifold to the interior of said hood; and
a source of air coupled to said manifold.

4. The spray nozzle assembly as set forth in claim 5 further including third means to illuminate the remote location.

5. The spray nozzle assembly as set forth in claim 4 wherein said first means is a video camera.

6. The spray nozzle assembly as set forth in claim 5 wherein said video camera is battery powered.

7. The spray nozzle assembly as set forth in claim 6 wherein said first means comprises a fiber optic viewing system.

8. The spray nozzle assembly as set forth in claim 7 wherein said second means is a battery powered flashlight.

9. The spray nozzle assembly as set forth in claim 8 wherein the tubular member is made of flexible material.

10. The spray nozzle assembly as set forth in claim 9 wherein the tubular member is made of semi-flexible material.

11. The spray nozzle assembly as set forth in claim 10 wherein the tubular member is made of rigid material.

12. A spray coating system comprising:
a spray gun coupled to a source of coating material; and
a nozzle assembly:
a tubular member having first and second ends, said first end coupled to the spray gun;
a spray nozzle housing coupled to said second end of said tubular member, said spray nozzle housing containing a spray nozzle;
first means to observe the remote location coupled to said housing, said first means having an optical viewing port; and
second means coupled to said optical view port for providing air under pressure thereto to prevent paint spray from said spray nozzle contacting said optical viewing port.

13. The spray nozzle assembly as set forth in claim 12 wherein:
said second means includes an optical sensing device;
said second means includes:
a hood extending from said optical sensing device; and
an air supply system for providing air to said hood for preventing coating material from reaching said optical sensing device.

14. The spay nozzle assembly as set forth in claim 13 wherein:
said air supply system includes:
a manifold about said hood;
a plurality of holes extending from said manifold to the interior of said hood; and
a source of air coupled to said manifold.

15. The spray nozzle assembly as set forth in claim 14 further including third means to illuminate the remote location.

16. The spray nozzle assembly as set forth in claim 15 wherein said first means is a video camera.

17. The spray nozzle assembly as set forth in claim 16 wherein said video camera is battery powered.

18. The spray nozzle assembly as set forth in claim 17 wherein said first means comprises a fiber optic viewing system.

19. The spray nozzle assembly as set forth in claim 18 wherein said second means is a battery powered flashlight.

20. The spray nozzle assembly as set forth in claim 19 wherein the tubular member is made of flexible material.

21. The spray nozzle assembly as set forth in claim 20 wherein the tubular member is made of semi-flexible material.

22. The spray nozzle assembly as set forth in claim 21 wherein the tubular member is made of rigid material.
